(19) United States
(12) Patent Application Publication
(10) Pub. No.: US 2025/0060205 A1
(43) Pub. Date: Feb. 20, 2025

(54) DEVICES AND METHODS FOR MEASURING MUSICAL INSTRUMENT STRINGS

(71) Applicant: GOTCHOPS MUSIC INC, New York, NY (US)

(72) Inventor: Shawn P. FERGUSON, New York, NY (US)

(21) Appl. No.: 18/807,543

(22) Filed: Aug. 16, 2024

Related U.S. Application Data
(60) Provisional application No. 63/520,567, filed on Aug. 18, 2023.

(51) Int. Cl. G01B 3/42; G01B 5/06; G10D 3/10

(52) U.S. Cl. CPC G01B 3/42; G01B 5/06; G10D 3/10

(57) ABSTRACT

Embodiments described herein relate to an instrument string gauge. The instrument string gauge includes a gauge body and a plurality of slots arranged around the perimeter of the gauge body. Each slot of the plurality of slots defines a width that is different from the width of the other slots of the plurality of slots. Each slot of the plurality of slots is configured to receive a string of an instrument having a width that is less than or equal to width of the respective slot to indicate to a user an approximate width of the string.

### CROSS-REFERENCE TO RELATED APPLICATIONS

This application claims priority to and benefit of U.S. Provisional Patent Application No. 63/520,567, titled “DEVICES AND METHODS FOR MEASURING MUSICAL INSTRUMENT STRINGS,” filed Aug. 18, 2023, the disclosure of which is incorporated herein by reference.

### TECHNICAL FIELD

Embodiments described herein relate to gauges for measuring musical instrument strings.

### BACKGROUND

String instruments are musical instruments that utilize the vibration of one or more strings to produce sound. During use, the strings can become worn out, damaged, or broken. Replacing strings involves choosing string gauges to achieve a desired sound from each string. However, the gauge of the old string and/or the new string may not be known. This may result in inconsistent and/or undesirable sound associated with string replacement.

Traditional gauges are generally used for electrical wiring applications. These gauges are often designed for repeated use in settings where they may become damaged. Their rugged design can scratch the delicate surfaces of instruments. Thus there is a need for a string gauge that can be safely used on string instruments.

### SUMMARY

In some embodiments, an instrument string gauge includes a gauge body. The instrument string gauge further includes a plurality of slots arranged around the perimeter of the gauge body. Each slot of the plurality of slots defines a width that is different from the width of the other slots of the plurality of slots. Each slot of the plurality of slots is configured to receive a string of an instrument having a width that is less than or equal to width of the respective slot to indicate to the user an approximate width of the string.

In some embodiments, an instrument string gauge includes a holder comprising a first portion and a second portion. The instrument string gauge further includes at least one width gauge partially disposed between the first portion and the second portion such that at least a portion of the at least one width gauge protrudes outwards of a perimetral edge of the first portion and the second portion.

### BRIEF DESCRIPTION OF THE DRAWINGS

FIG. 1 is a block diagram of a string gauge device, according to an embodiment.

FIG. 2 depicts a gauge, according to an embodiment.

FIGS. 3A-3B depicts a string gauge device with different gauge configurations, according to embodiments.

FIGS. 4A-4B depicts string gauge devices with triangular holders, according to embodiments.

FIG. 5 depicts a string gauge device with a rectangular holder, according to an embodiment.

FIG. 6 depicts a string gauge device with a heart-shaped holder, according to an embodiment.

FIGS. 7A-7B depict string gauge devices with acoustic guitar-shaped holders, according to various embodiments.

FIGS. 8A-8B depicts string gauge devices with electric guitar-shaped holders, according to various embodiments.

FIGS. 9A-9B depicts string gauge devices with other electric guitar-shaped holders, according to various embodiments.

FIGS. 10A-10B depict a string gauge device engaging with instrument strings, according to various embodiments.

FIGS. 11A-11B depict another string gauge device engaging with instrument strings, according to various embodiments.

FIG. 12 is a method of using a string gauge device, according to an embodiment.

### DETAILED DESCRIPTION

Embodiments described herein relate to devices (e.g., gauges) and methods for measuring a characteristic (e.g., width, gauge, etc.) of a string (e.g., wire, etc.). In some embodiments, the gauge described herein are configured to measure strings for a musical instrument that utilizes strings to produce sound. For example, the musical instrument can be a guitar (e.g., classical guitar, acoustic guitar, electric guitar, bass guitar, baritone guitar, etc.), ukulele, banjo, violin, cello, contrabass, piano, harp, sitar, and/or the like. The gauge described herein can be used to measure various types of strings, such as nylon strings, gut string, steel strings, and/or the like.

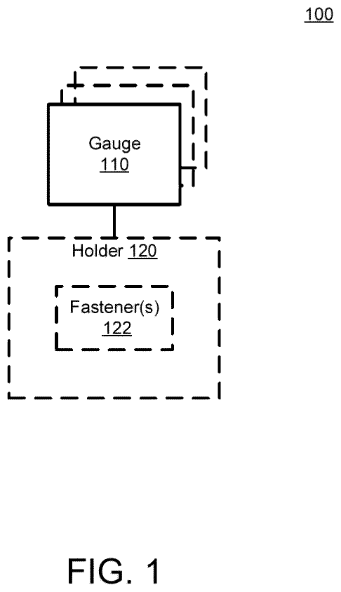

FIG. 1 is a block diagram of a string gauge device 100, according to an embodiment. The string gauge device 100 is configured to measure a thickness of musical instrument strings. The string gauge device 100 includes a gauge 110. In some embodiments, the string gauge device 100 can include more than one gauge 110. For example, the string gauge device 100 can include multiple gauges 110, each configured to measure different instrument strings. More specifically, a first gauge 110 can be for measuring strings with a first set of gauges, a second gauge 110 can be for measuring strings with a second set of gauges, and a third gauge 110 can be for measuring string with a third set of gauges. For example, the first set of gauges can correspond to the thicknesses of electric guitar strings, the second set of gauges can correspond to the thicknesses of acoustic guitar strings, and the third set of gauges can correspond to the thicknesses of bass guitar strings. In some embodiments, the string gauge device 100 includes multiple gauges 110, each gauge 110 a different size (e.g., circumference, perimeter, width, length, thickness, etc.). In some embodiments, the string gauge device 100 can be configured for one instrument type or for more than one instrument type. In some embodiments, the string gauge device 100 is configured to engage with a string affixed to an instrument.

The gauge 110 is configured to accept instrument strings, so that the thickness of the instrument strings can be determined. In some embodiments, the gauge 110 is circular, triangular, rectangular, pentagonal, or the like. In some embodiments, the gauge 110 is shaped like a musical instrument. For example, the shape of the gauge 110 can correspond to the type of musical instrument the gauge 110 is configured to measure strings for. The body of the gauge 110 defines a plurality of slot arranged around the perimeter of the gauge. Each slot of the plurality of slots defining a width that is different from the width of the other slots of the plurality of slots. Each slot is configured to receive a string of an instrument having a width that is less than or equal to the width of the respective slot. A user can engage the slots with instrument strings to determine an approximate width of the instrument string. The widths of the plurality of slots can correspond to gauges that are commonly grouped together, such as strings for a particular instrument, standard instrument gauges, gauges used by a particular musician, and/or the like.

In some embodiments, the gauge 110 is configured so that engaging the string gauge device 100 with an instrument does not damage (e.g., scratch, scuff, etc.) the instrument. In some embodiments, the gauge 110 is formed of a soft material (e.g., material that will not damage an instrument), such as rubber, plastic, and/or the like. In some embodiments, the gauge 110 is coated with a soft material. In some embodiments, the slots are coated or lined with a soft material. In some embodiments, the gauge 110 includes a textured surface (e.g., etched surfaced, rough coating, etc.) that increases friction when between a user's fingers and the gauge 110 to enhance the user's grip on the gauge 110 and facilitate maneuvering. In some embodiments, the gauge 110 is formed of a rigid material so that the gauge 110 does not deform during use. In some embodiments, the gauge is formed of a material softer than metal, as to not damage an instrument and harder than a material that would flex during use. As used herein, the soft material may include any material that has a shore hardness of equal to or less than Shore 60A.

The holder 120 is configured to house the gauge 110. In some embodiments, the holder 120 is configured to house multiple gauges 110. In some embodiments, the holder 120 includes a first portion and a second portion with the gauge 110 being partially disposed between the first portion and the second portion. In some embodiments, the first portion and the second portion are the same shape. In some embodiments, a gauge 110 is coaxially located with a central axis of the holder 120 so that the gauge 110 is centered. In some embodiments, the gauge 110 is located off center on the holder 120. In some embodiments, one or more gauges 110 are distributed equally along the perimeter of the holder 120. In some embodiments, the one or more gauges 110 are distributed based on the size of the gauges 110. In some embodiments, the gauge 110 is rotatably coupled to the holder 120. In some embodiments, the gauge 110 is coupled to the holder 120 via the fastener(s) 122. The fastener(s) 122 can be any fastener that allows the gauge 110 to rotate about a coupling point on the holder 120. In some embodiments, the fastener(s) 122 can allow for the gauge 110 to be selectively coupled to the holder 120 so that the gauge 110 can be removed and/or swapped. In some embodiments, the fastener(s) 122 can include pins, rivets, and/or the like. In some embodiments, each gauge 110 corresponds to one fastener 122 of the fastener(s) 122. For example, a first gauge 110 is coupled to the holder 120 via a first fastener 122, a second gauge 110 is coupled to the holder 120 via a second fastener 122, and a third gauge 110 is coupled to the holder 120 via a third fastener 122.

In some embodiments, the holder 120 is shaped like a musical instrument and/or musical instrument implement or device. For example, the shape of the holder 120 can be that of a guitar pick, an amplifier, a guitar (e.g., left-handed guitar, right-handed guitar, acoustic guitar, classical guitar, hollow-body guitar, solid-body guitar, etc.), and/or the like. In some embodiments, the shape of the holder 120 corresponds to the type of instrument with which the string gauge device 100 is configured to be used. In some embodiments, the holder 120 can be another shape such as a heart, a circle, a triangle, rectangle, and/or the like. In some embodiments, the holder 120 can be printed with a graphic. The graphic can depict a corresponding instrument, instructional information, a logo, a pattern, an advertisement, and/or the like.

In some embodiments, the holder 120 is configured so that engaging the string gauge device 100 with an instrument does not damage (e.g., scratch, scuff, etc.) the instrument. In some embodiments, the holder 120 is formed of a soft material (e.g., material that will not damage an instrument), such as rubber, plastic, and/or the like. In some embodiments, the holder 120 is coated with a soft material. In some embodiments, the holder 120 is partially coated with a soft material. For example, only the edges, and any other portion that may touch an instrument, of the holder 120 are coated with a soft material. In some embodiments, the holder 120 includes a textured surface (e.g., etched surface, rough coating, etc.) so that a user can grip the holder 120.

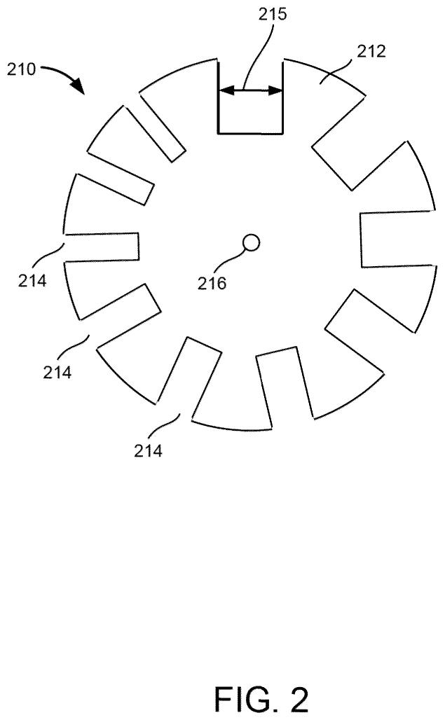

FIG. 2 depicts a gauge 210 (e.g., structurally and/or functionally similar to the gauge 110 of FIG. 1), according to an embodiment. In some embodiments, the gauge 210 is a portion of a string gauge device, such as the string gauge device 100 of FIG. 1. In some embodiments, the gauge 210 functions as a string gauge device, such as the string gauge device 100 of FIG. 1. The gauge 210 is formed of a gauge body 212 which defines a plurality of slots 214 and a fastener aperture 216. The gauge body 212 is a substantially circular disc shape. In some embodiments, the gauge body 212 can be a different shape such as a triangle, rectangle, pentagon, and/or the like. In some embodiments, the gauge body 212 can be an irregular shape (e.g., shape with uneven edges, asymmetrical shape, etc.). The gauge body 212 defines a thickness. In some embodiments, the thickness is greater than a threshold thickness that allows for the gauge body 212 to maintain its shape during use and prevents deformation. The circumference of the gauge body 212 can be determined as a length that allows for a desired number of slots 214 to be defined within the gauge body 212. In some embodiments, the gauge body 212 includes curved corners at each slot 214 to decrease the likelihood of the gauge body 212 scratching an instrument when the gauge 210 is engaging the instrument. In some embodiments, the gauge body 212 is formed of a soft material. In some embodiments, the gauge body 212 is formed of a rigid material and coated in a soft material. In some embodiments, only the portions of the gauge body 212 that may engage an instrument are coated with a soft material. In some embodiments, the diameter of the gauge body 212 is between about 30 mm and about 45 mm inclusive of all ranges and values therebetween. In some embodiments, the diameter of the gauge body 212 can be dependent on the type of instrument and/or strings that the gauge body 212 is configured to measure.

The plurality of slot 214 include channels defined by the gauge body 212, for example, along a perimeter of the gauge body 212, with each of the plurality of slots defining a width 215. The width 215 of each slot 214 of the gauge 210 is different as to measure a different width instrument string. In some embodiments, the slots 214 can include multiple slots with the same width for redundancy. In some embodiments, the width 215 of the slots 214 correspond to standard instrument string widths. In some embodiments, the width 215 of each slot 214 is printed, etched, or the like, on the gauge body 212 adjacent to a corresponding slot 214. The plurality of slots 214 define a depth that is sufficient for a corresponding string to be inserted to at least the widest point of the string, thus allowing the string to be measured by the slot 214. In some embodiments, the plurality of slots 214 are arranged around the perimeter of the gauge body 212 so that the width 215 increases or decreases along the perimeter from one slot 214 to the adjacent slot 214.

The fastener aperture 216 is an opening in the gauge body 212 that functions as a through-hole for a fastener. The fastener aperture 216 can be a circular shape or another shape corresponding to the shape of a portion of a corresponding fastener. In some embodiments, the fastener aperture 216 can be located along a central axis of the gauge body 212. In some embodiments, the fastener aperture 216 can be located at any point on the gauge body 212 around which the gauge 210 is configured to rotate. In some embodiments, the gauge 210 does not include a fastener aperture 216.

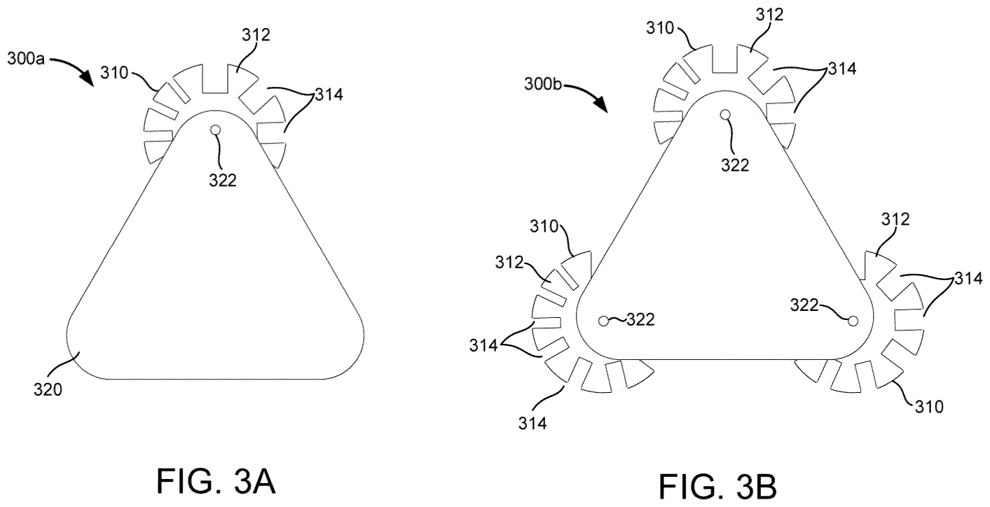

Referring generally to FIGS. 3A-3B, string gauge devices (300a and 300b) (e.g., functionally and/or structurally similar to the string gauge device 100 of FIG. 1) are shown with different gauge 310 configurations. The string gauge devices (300a and 300b) each include a holder 320 (e.g., structurally and/or functionally similar to the holder 120 of FIG. 1) and at least one gauge 310 (e.g., structurally and/or functionally similar to the gauge 110 of FIG. 1 and/or the gauge 210 of FIG. 2). The holder 320 is triangular. In some embodiments, additional configuration of string gauge devices are possible. For example, the holder 320 can be a different shape, the gauges 310 can include different slot 314, the string gauges can include a different number and/or layouts of gauges 310. The string gauge devices (300a and 300b) can be utilized for measuring instrument string widths. The string gauge devices (300a and 300b) can be for general use or can be configured for use with a specific music instrument and/or specific types of instrument strings.

FIG. 3A depicts the string gauge device 300a. The string gauge device 300a includes one gauge 310 comprising a plurality of slots 314. The gauge 310 is located at one corner of the triangular holder 320. The gauge 310 is rotatably coupled to the holder 320 via a fastener 322. The string gauge device 300a can be configured to use with one specific type of instrument strings (e.g., a group of gauges, a type of instrument, etc.). FIG. 3B depicts the string gauge device 300b. The string gauge device 300b includes three gauges 310 fastened to the holder 320 via fasteners 322. The gauges 310 are located on each corner of the triangular holder 320. The gauges 310 of the string gauge device 300b can all be the same gauge 310 or can be different gauges 310. For example, each gauge 310 can be the same gauge 310 for redundancy. As another example, each gauge 310 can be a different gauge such that each gauge is for a different type of string. For example, one gauge 310 can be for first instrument type, a second gauge 310 can be for a second instrument type, and a third gauge 310 can be for a third instrument type. As another example, one gauge 310 can be for one group of string gauges, a second gauge 310 can be for a second group of string gauges, and a third gauge 310 can be for third group of string gauges. In some embodiments, the gauges 310 of the string gauge devices (300a and 300b) can be swapped with gauges 310.

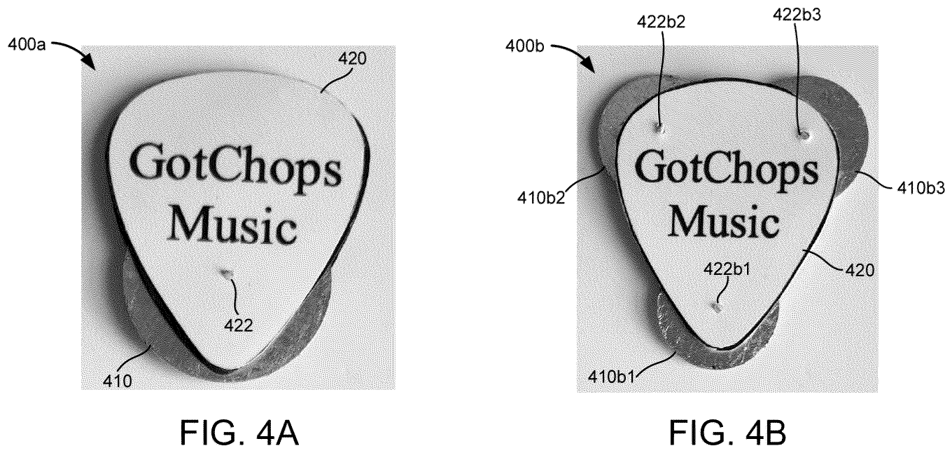

Referring generally to FIGS. 4A-9B, various string gauge devices (400a, 400b, 500, 600, 700a, 700b, 800a, 800b, 900a, and 900b) which are structurally and/or functionally similar to any of the string gauge devices described herein. The string gauge devices (400a, 400b, 500, 600, 700a, 700b, 800a, 800b, 900a, and 900b) can be used or utilized for a different purpose. While the string gauge devices (400a, 400b, 500, 600, 700a, 700b, 800a, 800b, 900a, and 900b) include example gauges (e.g., structurally and/or functionally similar to the gauge 110 of FIG. 1, the gauge 210 of FIG. 2, and/or the gauges 310 of FIGS. 3A-3B) that do not include slots, in operation, the string gauge devices (400a, 400b, 500, 600, 700a, 700b, 800a, 800b, 900a, and 900b) would include slots for measuring instrument strings. Any of the string gauge devices (400a, 400b, 500, 600, 700a, 700b, 800a, 800b, 900a, and 900b) can include additional and/or fewer gauges in various locations.

FIGS. 4A-4B depicts string gauge devices (400a and 400b) with triangular holders 420, according to embodiments. The holders 420 are shaped like an isosceles triangle with curved edges similar to the shape of a guitar pick. As seen in FIG. 4A, a gauge 410 can be rotatably coupled to one corner of the holder 420 via a fastener 422. The corner of the holder 420 which the gauge 410 is coupled to may correspond to the portion of a guitar pick that generally engages the strings. As seen in FIG. 4B, gauges (410b1, 410b2, 410b3) can be located at each corner of the holder 420 and are each rotatably coupled to the holder 420 via fasteners (422b1, 422b2, 422b3). In some embodiments, each gauge of the gauges (410b1, 410b2, 410b3) corresponds to a different type of instrument string or group of string gauges. In some embodiments, the holder 120 may be printed, embossed, or the like with a logo, advertisement, and/or the like.

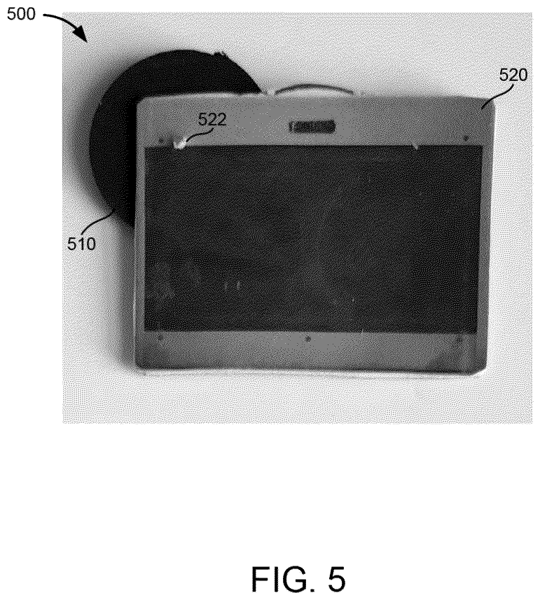

FIG. 5 depicts a string gauge device 500 with a rectangular holder 520, according to an embodiment. The rectangular holder 520 may be shaped like and/or printed with a guitar amplifier design. The string gauge device 500 includes a gauge 510 rotatably coupled to the holder 520 via a fastener 522. The gauge 510 is coupled to the holder 520 at one corner. In some embodiments, the gauge 510 may be coupled to the holder 520 at any other suitable location, for example another corner, or an edge between two corners.

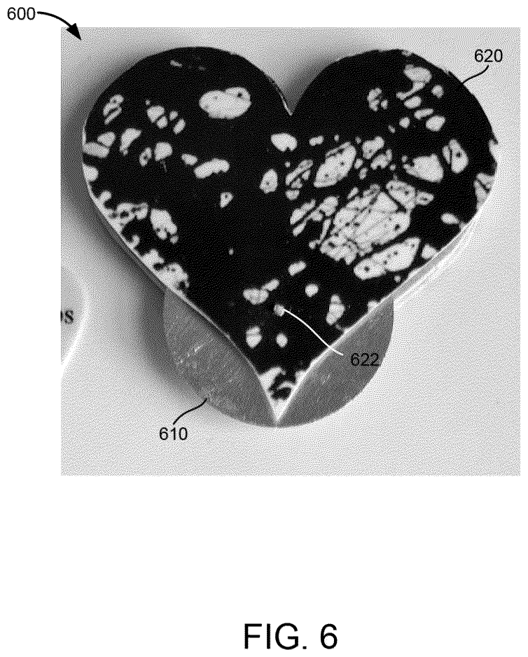

FIG. 6 depicts a string gauge device with a heart-shaped holder 620, according to an embodiment. In some embodiments, the holder 620 includes a surface with a design. The string gauge device 600 includes a gauge 610 rotatably coupled to the holder 620 via a fastener 622. The gauge 610 is coupled to the holder 620 at one end of the heart-shaped holder 620. In some embodiments, the gauge 610 may be coupled to another location on the holder 620.

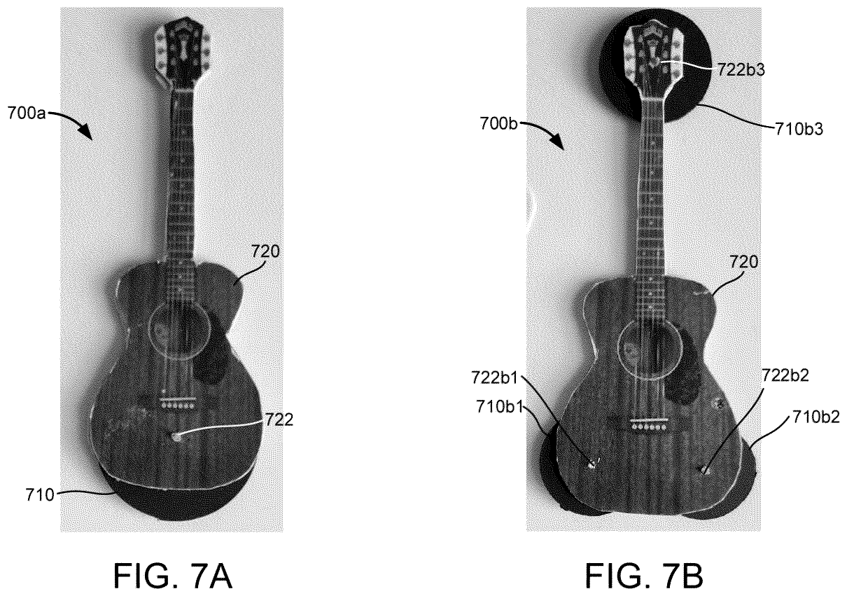

FIGS. 7A-7B depict string gauge devices (700a and 700b) with acoustic guitar-shaped holders 720, according to embodiments. The holder 720 are shaped and colored like acoustic guitars. The string gauge device 700a includes a gauge 710 coupled to the holder 720 at the body-portion of the acoustic guitar-shaped holder 720. As seen in FIG. 4B, gauges (710b1, 710b2, 710b3) are each rotatably coupled to the holder 420 via fasteners (722b1, 722b2, 722b3). In some embodiments, each gauge of the gauges (710b1, 710b2, 710b3) corresponds to a different type of instrument string or group of string gauges. The gauge 710b1 is located at one side of the body of the guitar-shaped holder 720 and the gauge 710b2 is located on an opposite side of the body of the guitar-shaped holder 720. The gauge 710b3 is located at the headstock of the guitar-shaped holder 720.

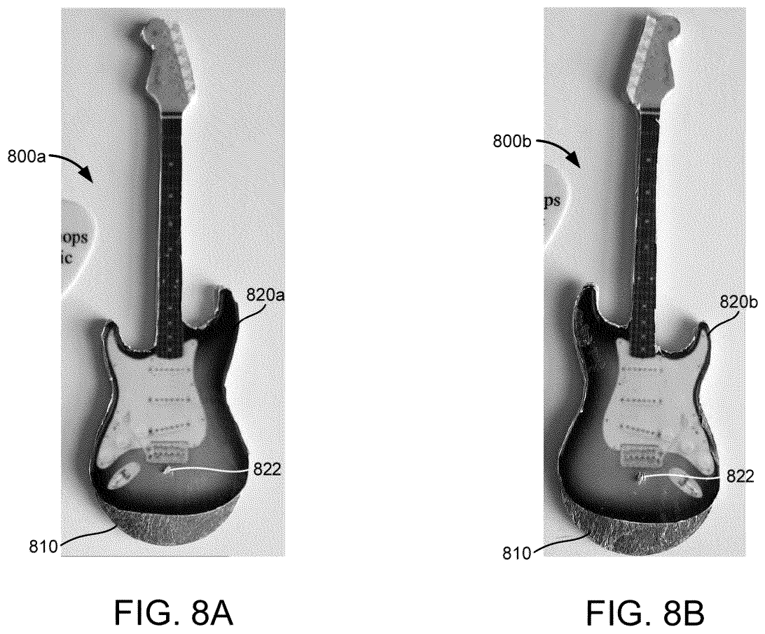

FIGS. 8A-8B depicts string gauge devices (800a and 800b) with electric guitar-shaped holders (820a and 820b), according to embodiments. The holders (820a and 820b) have s-style guitar body shapes. The holder 820a is a left-handed guitar shape and the holder 820b is a right-handed guitar shape. The string gauge device (800a and 800b) include a gauge 810 rotatably coupled to the holders (820a and 820b) via a fastener 822. In some embodiments, the string gauge devices (800a and 800b) can include additional gauges. For example, the string gauge devices (800a and 800b) can include an additional gauge at the headstock of the holders (820a and 820b).

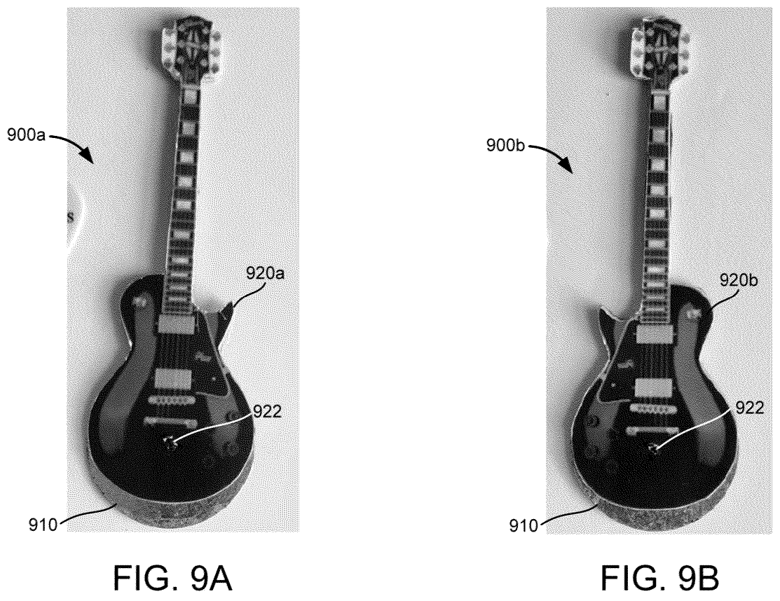

FIGS. 9A-9B depicts string gauge devices (900a and 900b) with electric guitar-shaped holders (920a and 920b), according to embodiments. The holders (920a and 920b) are Les Paul style guitar body shapes. The holder 920a is a right-handed guitar shape and the holder 920b is a left-handed guitar shape. The string gauge devices (900a and 900b) include a gauge 910 rotatably coupled to the holders (920a and 920b) via a fastener 922. In some embodiments, the string gauge devices (900a and 900b) can include additional gauges. For example, the string gauge devices (900a and 900b) can include an additional gauge at the headstock of the holders (920a and 920b).

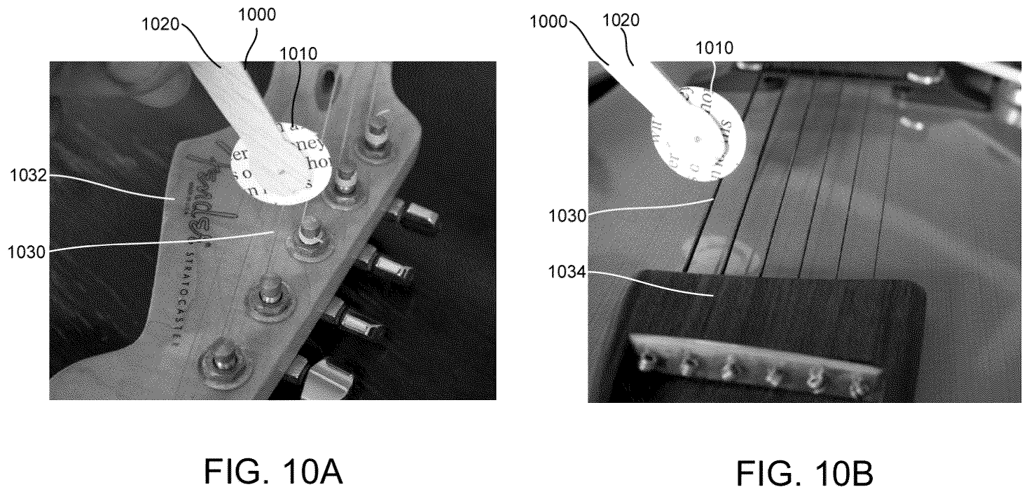

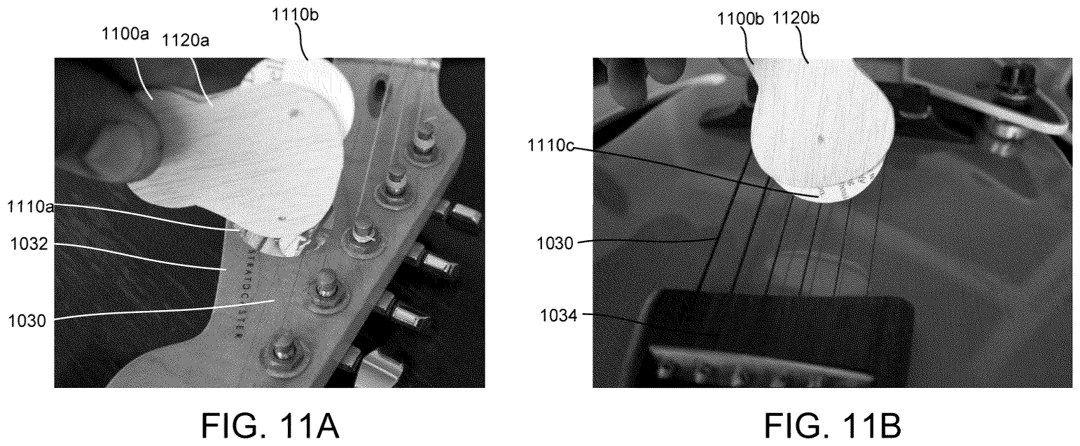

FIGS. 10A-10B and FIGS. 11A-11B depict string gauge devices (1000, 1100a, and 1100b) engaging with instrument strings 1030, according to embodiments. The string gauge device 1000 includes an oblong holder 1020 with a gauge 1010 rotatably coupled to an end of the holder 1020. As seen in FIGS. 10A and 11A, the string gauge devices (1000 and 1100a) can engage an instrument string 1030 at the headstock 1032 and, as seen in FIGS. 10B and 11B), the string gauge devices (1000 and 1100b) can engage the instrument string 1030 at a guitar body 1034.

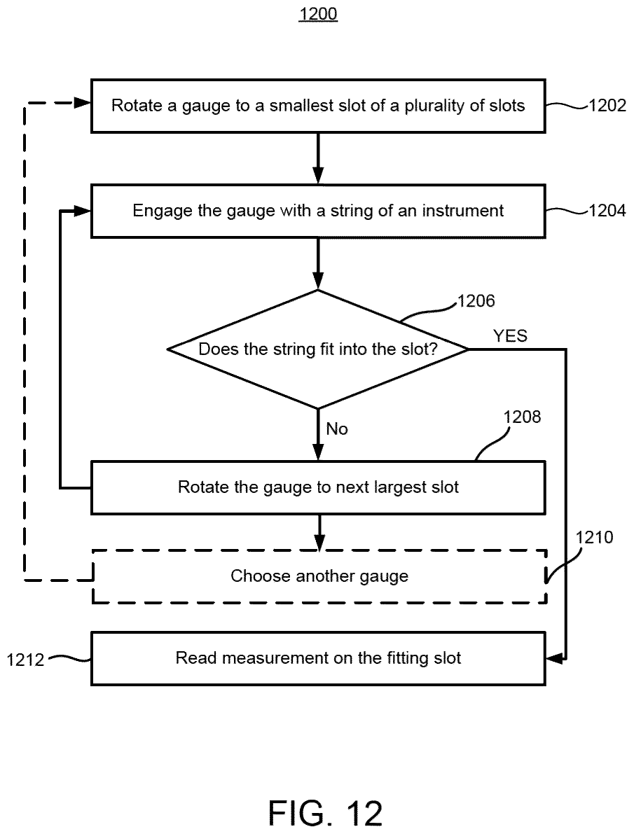

FIG. 12 is a method 1200 of using a string gauge device (e.g., structurally and/or functionally similar to any one of the string gauge devices described herein), according to an embodiment. The method 1200 can be utilized for utilizing any shape and/or configuration of string gauge.

The method 1200 begins at operation 1202 with rotating a gauge that may be coupled to a holder, to a smallest slot of a plurality of slots. In some embodiments, the smallest slot of the plurality of slots can include an indicator. At 1204, the gauge is engaged with the string of an instrument. The instrument can be any instrument that includes a string (e.g., guitar, violin, piano, cello, bass, etc.). At 1206, it is determined if the string fits in the slot that engaged the string in operation 1204. If the string fits in the slot, the method 1200 continues to operation 1212, where the measurement on the slot is read, which corresponds to the gauge of the string.

If the string does not fit into the slot, the method 1200 continues to operation 1208. At 1208, the gauge is rotated to the next largest slot of the gauge. The method then returns to operation 1204 and the newly chosen slot is engaged with the string and the method again continues to operation 1206. If at 1208, there is no larger slot available, the method 1200 optionally continues to operation 1210 where another gauge of the string gauge device is selected and the method proceeds to operation 1202.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of slots, the set of slots can be considered as one slot with multiple portions, or the set of slots can be considered as multiple, distinct slots. Additionally, for example, when referring to a plurality of gauges, the plurality of gauges can be considered as multiple, distinct gauges or as one gauge with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An instrument string gauge comprising:
a gauge body; and
a plurality of slots arranged around the perimeter of the gauge body, each slot of the plurality of slots defining a width that is different from a width of the other slots of the plurality of slots, each slot of the plurality of slots configured to receive a string of an instrument having a width that is less than or equal to width of the respective slot to indicate to a user an approximate width of the string.

2. The instrument string gauge of claim 1, further comprising:
a holder comprising a first portion and a second portion, the gauge body partially disposed between the first portion and the second portion.

3. The instrument string gauge of claim 2, wherein the gauge body is rotatably coupled to the holder.

4. The instrument string gauge of claim 3, wherein the gauge body is coupled to the holder via a pin.

5. The instrument string gauge of claim 2, wherein the holder is formed of a soft material.

6. The instrument string gauge of claim 2, wherein the holder is coated with a soft material.

7. The instrument string gauge of claim 1, wherein the gauge body is formed of a soft material.

8. The instrument string gauge of claim 1, wherein the gauge body is coated with a soft material.

9. The instrument string gauge of claim 1, wherein the gauge body is circular.

10. The instrument string gauge of claim 9, wherein the gauge body defines a diameter of between about 30 mm and about 45 mm.

11. The instrument string gauge of claim 1, wherein the gauge body is formed of a rigid material.

12. An instrument string gauge, comprising:
a holder comprising a first portion and a second portion; and
at least one width gauge partially disposed between the first portion and the second portion such that at least a portion of the at least one width gauge protrudes outwards of a perimetral edge of the first portion and the second portion.

13. The instrument string gauge of claim 12, wherein the at least one width gauge includes a first width gauge located at a first location between first portion and the second portion, and a second width gauge located at a second location between first portion and the second portion different from the first location.

14. The instrument string gauge of claim 12, wherein:
the first width gauge includes a first set of slots located around a perimeter of the first width gauge,
the second width gauge includes a second set of slots located around a perimeter of the second width gauge, and
each of the first set of slots having widths that are different than corresponding widths of each of the second set of slots.

15. The instrument string gauge of claim 13, wherein the at least one width gauge further includes a third width gauge located at a third location between first portion and the second portion different from the first location and the second location.

16. The instrument string gauge of claim 15, wherein:
the first width gauge includes a first set of slots located around the perimeter of the first width gauge,
the second width gauge includes a second set of slots located around the perimeter of the second width gauge,
the third width gauge includes a third set of slots located around the perimeter of the second width gauge, and
each of the first set of slots, the second set of slots, and the third set of slots having respective widths that are different than widths of other slots included in the first set of slots, the second set of slots, or the third set of slots.

17. The instrument string gauge of claim 12, wherein a shape of the holder corresponds to a shape of the instrument that the at least one width gauge is configured to be used with.

18. The instrument string gauge of claim 12, wherein the at least one width gauge is rotatably coupled to the holder.

19. The instrument string gauge of claim 18, wherein the at least one width gauge is coupled to the holder via at least one pin.

20. The instrument string gauge of claim 12, wherein the at least one width gauge defines a diameter of between about 30 mm and about 45 mm.
